(19) United States
(12) Patent Application Publication
(10) Pub. No.: US 2004/0226011 A1
(43) Pub. Date: Nov. 11, 2004

(54) MULTI-THREADED MICROPROCESSOR WITH QUEUE FLUSHING

(75) Inventors: Victor R. Augsburg, Cary, NC (US); Jeffrey T. Bridges, Raleigh, NC (US); Michael S. McIlvaine, Wake Forest, NC (US); Thomas A. Sartorius, Raleigh, NC (US); R. Wayne Smith, Raleigh, NC (US)

Correspondence Address: INTERNATIONAL BUSINESS MACHINES CORPORATION, DEPT. 18G, BLDG. 300-482, 2070 ROUTE 52, HOPEWELL JUNCTION, NY, 12533, US

(73) Assignee: International Business Machines Corporation, Armonk, NY (US)

(21) Appl. No.: 10/249,793

(22) Filed: May 8, 2003

(51) Int. Cl. G06F 9/46

(52) U.S. Cl. 718/100

(57) ABSTRACT

In a multi-threading microprocessor, a queue for a scarce resource such as a multiplier alternates on a fine-grained basis between instructions in various threads. When a long-latency instruction is discovered in a thread, the instructions in that thread that depend on the latency are flushed out of the thread until the latency is resolved, with the instructions in other threads filling empty slots from the thread waiting for the long-latency instruction and continuing to execute without being delayed by having to wait for the long-latency instruction.

### BACKGROUND OF INVENTION

The field of the invention is that of microprocessors that execute multi-threaded programs, and in particular to the handling of blocked (waiting required) instructions in such programs.

Many modern computers support “multi-tasking” in which two or more programs are run at the same time. An operating system controls the alternation between the programs, and a switch between the programs or between the operating system and one of the programs is called a “context switch.” Additionally, multi-tasking can be performed in a single program, and is typically referred to as “multi-threading.” Multiple actions can be processed concurrently using multi-threading. Most multi-threading processors work exclusively on one thread at a time, (e.g. execute n instructions from thread a, then execute n instructions from thread b). There also exist fine-grain multi-threading processors that interleave different threads on a cycle-by-cycle basis. Both types of multi-threading interleave the instructions of different threads on long-latency events.

Most modern computers include at least a first level (level 1 or L1) and typically a second level (level 2 or L2) cache memory system for storing frequently accessed data and instructions. With the use of multi-threading, multiple programs are sharing the cache memory, and thus the data or instructions for one thread may overwrite those for another, increasing the probability of cache misses.

The cost of a cache miss in the number of wasted processor cycles is increasing. This is due to the fact that processor speed is increasing at a higher rate than the memory access speeds over the last several years and into the foreseeable future. Thus, more processor cycles are required for memory accesses, rather than less, as speeds increase. Accordingly, memory accesses are becoming a limited factor on processor execution speed.

In addition to multi-threading or multi-tasking, another factor that increases the frequency of cache misses is the use of object oriented programming languages. These languages allow the programmer to put together a program at a level of abstraction away from the steps of moving data around and performing arithmetic operations, thus limiting the programmer control of maintaining a sequence of instructions or data at the execution level to be in a contiguous area of memory.

One technique for limiting the effect of slow memory accesses is a “non-blocking” load or store (read or write) operation. “Non-blocking” means that other operations can continue in the processor while the memory access is being done. Other load or store operations are “blocking” loads or stores, meaning that processing of other operations is held up while waiting for the results of the memory access (typically a load will block, while a store won't). Even a non-blocking load will typically become blocking at some later point, since there is a limit on how many instructions can be processed without the needed data from the memory access.

Another technique for limiting the effect of slow memory accesses is a thread switch, in which the processor stops working on thread a until the data have arrived from memory and uses the time productively by working on threads b, c, etc. The use of separate registers for each thread and instruction dispatch buffers for each thread will affect the efficiency of operation. The foregoing assumes a non-blocking level 2 cache, meaning that the level 2 cache can continue to access for a first thread and it can also process a cache request for a second thread at the same time, if necessary.

Multi-thread processing can be performed in both hardware-based systems that have arrays of registers to store the instructions in a thread and sequence the instructions by stepping sequentially through the array; and in software-based systems that place the threads in fast memory with pointers to control the sequencing.

It would be desirable to have an efficient mechanism for switching between threads upon long-latency events.

### SUMMARY OF INVENTION

The present invention provides a method and apparatus for suspending the operation of a thread in response to a long-latency event.

In one embodiment, instructions from several threads are interleaved in a queue waiting to be processed by a scarce resource in the computer system such as an ALU (arithmetic-logic unit).

In another embodiment, the instructions in a thread after a long-latency instruction are flushed out of the queue until the latency is resolved, while execution proceeds on other threads.

In another embodiment, only instructions in that thread that are dependent on the latency are flushed and non-dependent instructions in the same thread continue.

In one embodiment, the instructions in each thread carry a thread field that identifies the location of the next instruction to be switched.

Preferably, in addition to the program address registers for each thread and the register files for each thread, instruction buffers are provided for each thread.

For a further understanding of the nature and advantages of the invention, reference should be made to the following description taken in conjunction with the accompanying drawings.

### BRIEF DESCRIPTION OF DRAWINGS

FIG. 1 is a block diagram of a prior art microprocessor.

FIG. 2 is a block diagram of a computer system including the processor of FIG. 1.

FIG. 3 is a diagram of a portion of the processor of FIG. 1 illustrating a form of multi-threading capability.

FIG. 4 is a diagram of a queue of instructions according to the present invention.

FIGS. 5 and 6 show the next step in a sequence.

### DETAILED DESCRIPTION

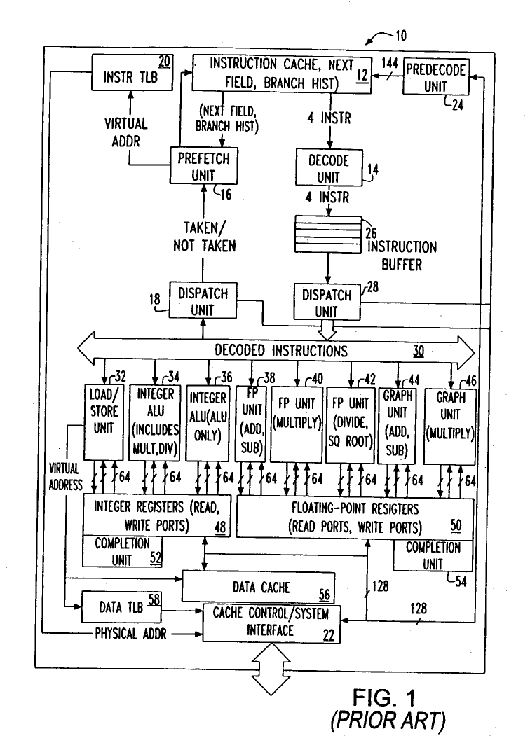

FIG. 1 is a block diagram of a microprocessor 10, as shown in U.S. Pat. No. 6,295,600, that could be modified to incorporate the present invention. This patent illustrates a system in which each queue contains only instructions from a single thread. An instruction cache 12 provides instructions to a decode unit 14. The instruction cache can receive its instructions from a prefetch unit 16, that either receives instructions from branch unit 18 or provides a virtual address to an instruction TLB (translation look-aside buffer) 20, which then causes the instructions to be fetched from an off-chip cache through a cache control/system interface 22. The instructions from the off-chip cache are provided to a pre-decode unit 24 to provide certain information, such as whether it is a branch instruction, to instruction cache 12.

Instructions from decode unit 14 are provided to an instruction buffer 26, where they are accessed by dispatch unit 28. Dispatch unit 28 will provide four decoded instructions at a time along a bus 30, each instruction being provided to one of eight functional units 32-46. The dispatch unit will dispatch four such instructions each cycle, subject to checking for data dependencies and availability of the proper functional unit.

The first three functional units, the load/store unit 32 and the two integer ALU units 34 and 36, share a set of integer registers 48. Floating-point registers 50 are shared by floating point units 38, 40 and 42 and graphical units 44 and 46. Each of the integer and floating point functional unit groups have a corresponding completion unit, 52 and 54, respectively. The microprocessor also includes an on-chip data cache 56 and a data TLB 58.

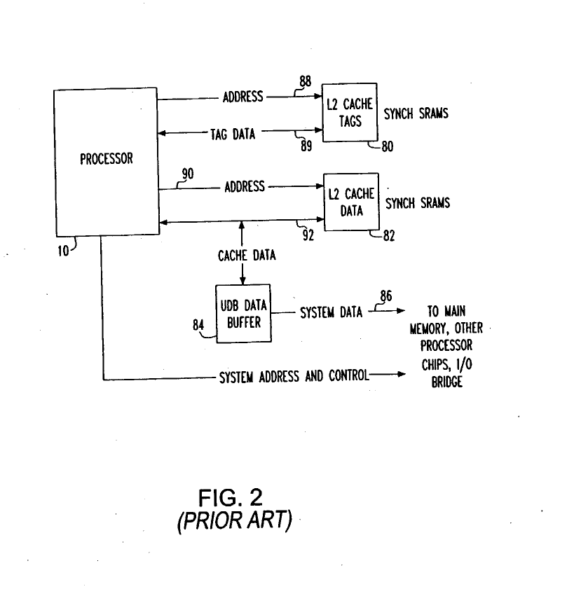

FIG. 2 is a block diagram of a chipset including processor 10 of FIG. 1. Also shown are L2 cache tags memory 80, and L2 cache data memory 82. In addition, a data buffer 84 for connecting to the system data bus 86 is shown. In the example shown, an address bus 88 connects between processor 10 and tag memory 80, with the tag data being provided on a tag data bus 89. An address bus 90 connects to the data cache 82, with a data bus 92 to read or write cache data.

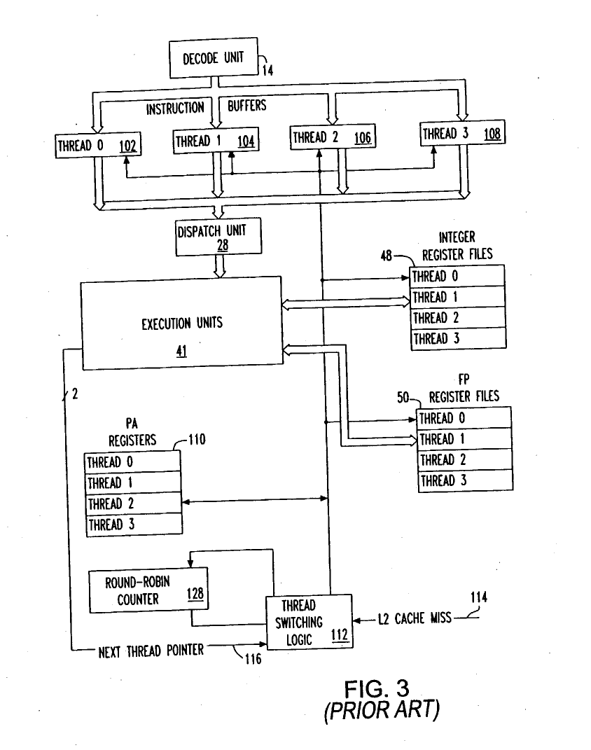

FIG. 3 illustrates portions of the processor of FIG. 1 modified to support a hardware based multi-thread system in which threads are operated on in sequential blocks. As shown, a decode unit 14 is the same as in FIG. 1. However, four separate instruction buffers 102, 104, 106 and 108 are provided to support four different threads, threads 0-3. The instructions from a particular thread are provided to dispatch unit 28, that then provides them to instruction units 41, which include the multiple pipelines 32-46 shown in FIG. 1.

Integer register file 48 is divided up into four register files to support threads 0-3. Similarly, floating point register-file 50 is broken into four register files to support threads 0-3. This can be accomplished either by providing physically separate groups of registers for each thread, or alternately by providing space in a fast memory for each thread.

This example has four program address registers 110 for threads 0-3. The particular thread address pointed to will provide the starting address for the fetching of instructions to the appropriate one of instruction buffers 102-108. Upon resolution of the latency, the stream of instructions in one of instruction buffers 102-108 will simply pick up where it left off.

Logic 112 is provided to give a hardware thread-switching capability. In this example, a round-robin counter 128 is used to cycle through the threads in sequence. The indication that a thread switch is required is provided on a line 114, e.g. providing an L2-miss indication from cache control/system interface 22 of FIG. 1. Upon such an indication, a switch to the next thread in sequence will be performed, using, in one embodiment, the next thread pointer on line 116. The next thread pointer is 2 bits indicating the next thread in sequence from a currently executing thread having an instruction that caused the cache miss. The mechanism of carrying out the required data changes, etc. when switching from one thread to another will be a design choice. Illustratively, conventional means not shown in execution unit 41 will access the correct locations in the buffers 102-108, the correct location in integer register files 48, FP (floating point) register files 50, etc. Those skilled in the art are aware that other pointers for various purposes are used in computer systems, e.g. to the next instruction in sequence in a thread, to the location in memory or to a register in the CPU where data from an instruction fetch is to be placed, etc. and that a pointer generally indicates a storage location where data or instructions are located or are to be placed. An illustrative example of an instruction includes an OP (operation) code field and source and destination register fields. By adding the 2 bit thread field to appropriate instructions, control can be maintained over thread-switching operations. In one embodiment, the thread field is added to all load and store operations. Alternately, it could be added to other potentially long-latency operations, such as jump instructions. In addition, the instructions would have a pointer to the next instruction in that particular thread.

In alternate embodiments, other numbers of threads could be used. There will be a tradeoff between an increase in performance and the cost and real estate of the additional hardware.

The programmable 2 bits for the thread field can be used to inter-relate two threads that need to be coordinated. Accordingly, the process could jump back and forth between two threads even though a third thread is available. Alternately, a priority thread could be provided with transitions from other threads always going back to the priority thread. In one embodiment the bits in the thread field would be inserted in an instruction at the time it is compiled. The operating system could control the number of threads that are allowed to be created and exist at one time. In a preferred embodiment, the operating system would limit the number to four threads.

Multi-threading may be used for user programs and/or operating systems.

The example discussed above is a hardware-based system, in which the queues are located in registers that have hardware to move the instructions up in the queue to reach the scarce resource. In another type of system, the queues are formed by locating the instructions in fast memory (e.g. a level 1 cache) and each instruction has a pointer to the next instruction. In such a case, it is not necessary to move the instruction to the next location in line; the system performs a memory fetch at the location pointed to and loads the instruction into the operating unit.

Preferably, the suspended thread will be loaded back into the queue immediately upon a completion of the memory access that caused the thread to be suspended; e.g. by generating an interrupt as soon as the memory access is completed. The returned data from the load must be provided to the appropriate register for the thread that requested it. This could be done by using separate load buffers for each thread, or by storing a two bit tag in the load buffer indicating the appropriate thread.

The approach taken in the present invention is that the instructions in the several threads will be interleaved on a fine-grained basis and that, when a thread has to wait for a memory fetch or some other long-latency event, the system will continue operating with the instructions in the other threads; and, in order to improve throughput, the instructions in the delayed thread will be moved elsewhere (referred to as “flushing” the queue) and the empty spaces will be filled with instructions from other threads. The length of the queue (the queue number of slots) has been selected as a design choice, typically balancing various engineering considerations. It is an advantageous feature of the invention that the queue has all its slots filled and therefore operates with its design capacity after a short transition period to flush and refill the queue.

In one embodiment, the present invention also supports non-blocking loads that allow the program to continue in the same program thread while the memory access is being completed. Preferably, such non-blocking loads would be supported in addition to blocking loads, which stall the operation of the program thread while the memory access is being completed. Thus, there would not be a thread switch immediately on a non-blocking load, but would be upon becoming a blocking load waiting for data (or store or other long-latency event).

In a preferred embodiment, the instruction set for the processor architecture does not need to be modified as the instruction set includes instructions required to support the present invention.

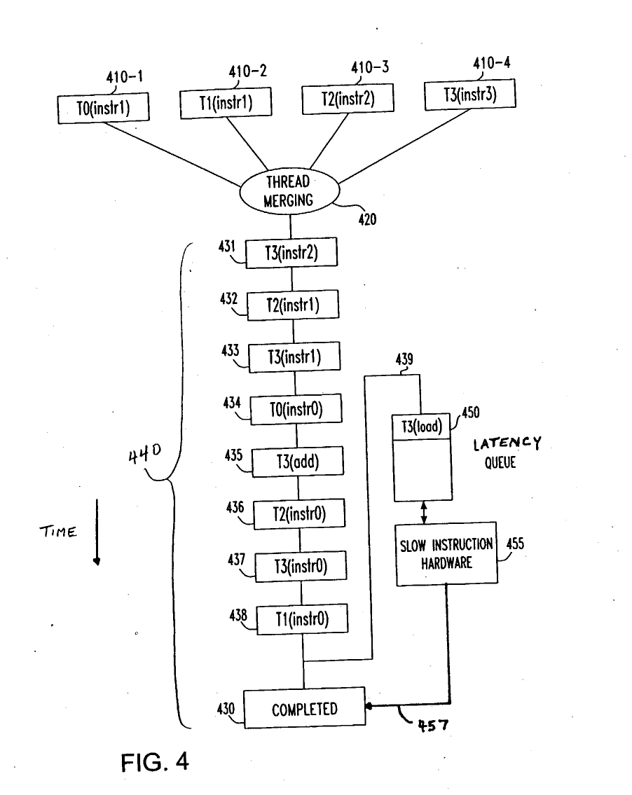

Referring to FIG. 4, there is shown a simplified view of a portion of a system showing a pipelined ALU and associated units. A group of boxes 410-n represent the instructions in four threads that are waiting to enter the ALU, denoted generally with numeral 440. The data flow is from top to bottom and, sequentially, the data enters box 431, is operated on, advances to box 432, etc. Boxes 410-n may represent a next instruction register or any other convenient method of setting up a thread. Sorting the program into threads has been done previously by the compiler and/or the operating system using techniques well known to those skilled in the art.

Oval 420, referred to as the thread merging unit, represents logic that merges the threads according to whatever algorithm is preferred by the system designer. Such algorithms are also well known in the art (e.g. a round robin algorithm that takes an instruction from each of the threads in sequence). Unit 420 will also have means to specify which threads are to be drawn on in the merge. After a flushing operation according to the invention, unit 420 will be instructed to not draw on that thread. When the data have arrived from memory, unit 420 will put the flushed instructions back in the queue and resume drawing on that thread.

Boxes 431-438 represent instructions being processed by pipelined ALU 440 or another unit that is shared between different threads. The boxes represent instructions passing through various stages in the pipeline and also hardware that operates on the instruction in the slot represented by the box. In this Figure, time is increasing from top to bottom as indicated by an arrow on the left of the Figure, i.e. an instruction starts in box 431, is shifted to box 432, then to box 433, etc. The particular example is chosen to illustrate that the sequence in the pipeline may or may not be in numerical order of the thread and may include two or more instructions from the same thread, depending on the particular algorithm. The notation is that (instr) means an instruction and (add) means add. Eight instructions are shown, coming from four threads. Other, much larger, numbers of instructions may be in a pipeline. The total number of instructions in the pipeline or queue will be referred to as the queue number. The process of adding instructions to the queue to replace instructions flushed out will be referred to as maintaining the queue number. The principles of the invention may be applied to many sequences of instructions, generally referred to as queues, in addition to a pipeline and the terms pipeline and queue will be taken to be equivalent, unless otherwise specified, for the purpose of discussing the invention.

If an instruction needs to fetch data from main memory, that instruction can not be executed until the data arrives. Another situation is one in which the instruction can be executed immediately, but takes a long time to complete, e.g. a division or other instruction that requires iteration. These and other instructions are referred to as long latency instructions because they delay other instructions for a relatively long time.

On the right of FIG. 4, box 450 is a queue for instructions that are waiting for data (load miss) or for other reasons, referred to as a latency queue. In this example, the load instruction associated with the instruction in box 435 has just been recognized as a load miss and an indication that thread T3 is waiting for a load has been placed at the top of box 450. When the data arrives, an instruction that has been flushed (and dependent instructions) will go back into the 440 queue. The same queue 450 can be used for lengthy instructions—i.e. the main 440 queue is used for short instructions and lengthy ones go into queue 450 that is connected to the slow instruction hardware 455 that performs a division operation or other lengthy instruction. This latter approach may require some duplication of hardware and the system designer will make a judgment call as to what hardware will be duplicated and what lengthy instructions will still remain in the main queue 440. The term “lengthy instruction” will be specified by the system designer, but is meant to include an instruction that takes sufficiently longer than a standard instruction to justify the extra hardware, e.g. more than the time to flush the queue and repopulate it. Thus, box 450 represents not only a load miss queue, but also part of a slow-instruction execution system. In the following claims, the term “long latency” will mean both instructions that are waiting for a memory fetch or other operations and also instructions that are operating without delay but take a relatively long time to execute.

When the data have arrived from memory, the flushed instructions are put back in the queue 440. As a design choice, the instruction that triggered the latency is placed at the head of the next instruction register (into box 410-4, in this example), so that unit 420 moves it to box 431 and it passes through the boxes until it reaches box 435. Dependent instructions (dependent on the outcome of the long latency instruction) will be put back into queue 440, illustratively by calling them in the usual sequence through thread merge 420 (whether they pass directly into unit 420 or through box 410-n is a design choice).

The result of lengthy instructions do not need to go into the ALU, so they will go to the output stage of the ALU along line 457 and then go on to the next step in processing (or, equivalently, the result will be passed on to the next location that receives the output of the ALU). For the purpose of the following claims, both alternatives will be referred to as transferring the output of the lengthy instruction operation to the output of the queue.

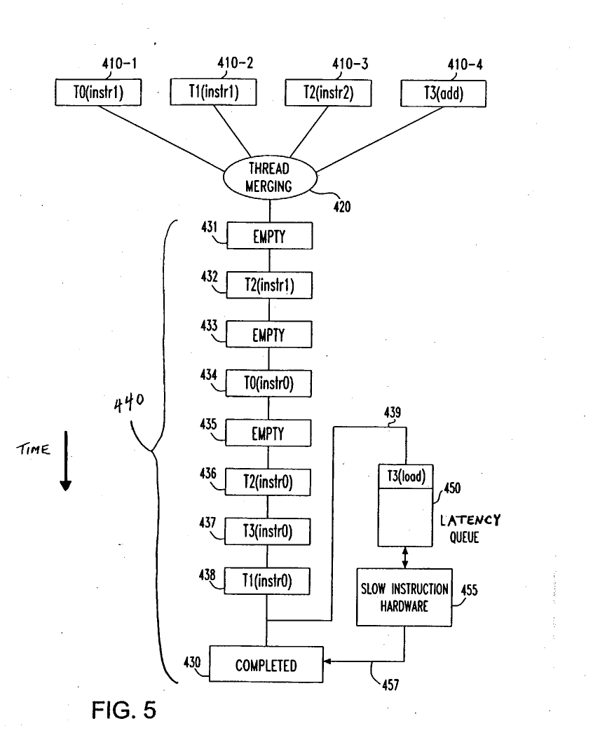

FIG. 5 shows the same elements after the first instruction shown in FIG. 4. Box 435 is now labeled “empty” indicating that the flush instruction has operated to remove that element of thread T3. Likewise, boxes 431 and 433 are also labeled empty, since those boxes also contained an element of the thread T3 (which are now stored outside queue 440, e.g. in box 410-4). Box 437, also containing an instruction from thread T3, is not labeled as being empty, since that instruction is not dependent on the long latency instruction and therefore does not need to be flushed.

In this Figure, boxes 410 are generic representations of the source of instructions in the threads and may be implemented in various ways, e.g. by a set of registers in the CPU containing the next group of instructions in the thread, by a set of instructions in cache memory, or by the program instructions in main memory. When we state that the instructions flushed from the pipeline are stored in box 410, they may have been placed in registers, moved to a cache, or simply erased and waiting to be called from main memory when the latency that caused the flush has been resolved and that particular thread is again processed. In the illustrated hardware embodiment, the flushing operation means that the register 435 is temporarily empty (until filled according to the invention). The load instruction that was part of, or associated with, the add instruction in box 435 is now in queue 450 and the add instruction that is to receive the material being loaded is now in buffer 410-4, waiting for resolution of the latency, when it will be placed back in the pipeline (either at the start or where it was when flushed). In a software embodiment of the type discussed above, in which the instructions are located in memory (e.g. L1 cache) and the connection between instructions is not a series of registers in a pipeline, but a field in each instruction that points to the location of the next instruction in the thread, the comparable result is that the pointer in the previous instruction in thread T3 (T3(instr0) in box 437 in FIG. 4) that used to point to the memory location of the instruction in box 435 in FIG. 4, now points to the location in memory of the instruction, T0(instr0), that was in box 434 in FIG. 4.

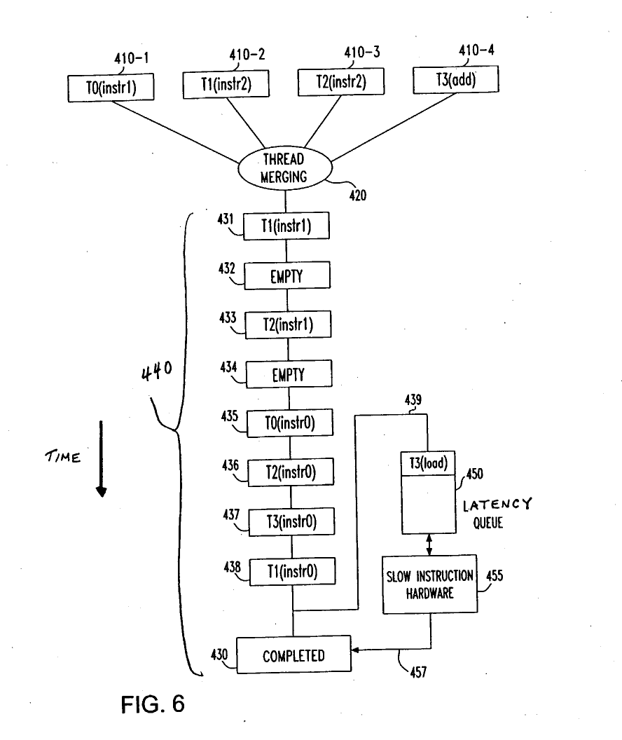

FIG. 6 shows the same elements one instruction cycle later, after the gap has been closed and box 435 has been filled with the former contents of box 434. Box 434 is now labeled empty because only one register can be shifted per instruction cycle in the particular system used as an example. The former contents of box 434 are now in box 435 and the contents of box 433 have not yet been moved to box 434. The boxes currently empty at this time will be filled in during subsequent cycles by transferring the next instruction in sequence into an empty box, leaving a newly empty box, replacing the newly empty box by the contents of the next box in sequence, etc. until all the boxes are filled with instructions from the other threads that are not waiting for the long latency instruction. In a hardware-based system, registers are expensive and it is preferable to take the time to move the instruction out of its register and then back into another register. In a software-based system, in which the queue is located in memory, there is no need to move the instruction. The pointers that locate the next instruction in a thread sequence and other pointers (referred to as pipeline pointers) representing the sequence of operation in pipeline 440 (in FIGS. 4-6) will be changed so that the flushed instruction are bypassed until the latency is satisfied. For example, the pipeline pointer indicating the instruction T0(instr0) that is the next instruction to undergo the operation represented by box 436 will be changed to indicate the instruction that was in box 434 in FIG. 5.

In a software embodiment, when the latency is resolved and the delayed thread is able to be processed, thread merge unit 420 or another unit will step though the queue and re-activate the pointers that have been bypassed. In that case, it is simple to give the long latency instruction (which has already passed through earlier operations in the pipeline) a high priority by delaying the instruction that was about to go through the operation that the long-latency instruction was flushed out of and putting the long-latency instruction back where it was when it was flushed (Box 435 in FIG. 4), e.g. in a slot that can operate on it in the next instruction cycle.

In any case, whether the long-latency instruction starts over in box 431 (or at the first step in a software embodiment) or whether it goes back to the location where it was when it was flushed will depend on design choices by the system designer, e.g. whether provision has been made for storing any intermediate or temporary data or results during the period of latency. As an example, suppose: a) that the instruction in question compares two items A and B and branches to one of two or more paths in the program, depending on the result of the comparison; and b) that the load miss was detected before the comparison is made. If the system designer has not made provision for storing A and B, then it will be easier to start that instruction over and recalculate A and B than to store them temporarily in a cache and fetch them back to be used by the instruction that has been placed back where it was when it was flushed.

The sequence of handling a long latency instruction (LLI) that is a load miss or other instruction that needs to wait may be illustrated in Table I.

TABLE I
Detect LLI (load miss) in the nth thread in a queue.
Transfer LLI to load miss queue
Detect instructions dependent on the LLI
Flush dependent (newer) instructions
Suppress instruction load from nth thread
When data arrives, place dependent instructions in queue (at the start or at
the location from which they were flushed)
Resume drawing instructions from the nth thread

In the case of a lengthy instruction, such as a division, the sequence is set out in Table II.

TABLE II
Detect LLI in the nth thread in a queue.
Transfer LLI to special queue accessing appropriate slow-instruction
hardware
Detect instructions dependent on the LLI
Flush dependent instructions
Suppress instruction load from nth thread
Perform lengthy instruction using slow-instruction hardware attached to
special queue
Pass result of LLI to output of the queue (or next step after queue)
When data arrives, place dependent instructions in queue (at the start or at
the location from which they were flushed)
Resume drawing instructions from the nth thread

The invention has been discussed in terms of a queue for an ALU, but any scarce resource in the system that operates on instructions from different threads may suffer a delay from a cache miss or other delay and could use the present invention. Thus, the invention could be applied in a number of locations in a system. In some applications, the implementation could be hardware based and, in the same system, other location(s) could be software based.

While the invention has been described in terms of a single preferred embodiment, those skilled in the art will recognize that the invention can be practiced in various versions within the spirit and scope of the following claims.

What is claimed is:

1. A method of executing instructions sorted in at least two threads in a processor system comprising at least one operating unit having a queue for instructions waiting to use said operating units in which:
at least one detection means detects long-latency instructions in the queue for said at least one operating unit;
flushing means flushes instructions of an nth thread that are in said queue when a long-latency instruction in said nth thread is detected by said detection means; and
instructions in other threads of said at least two threads are not flushed from said queue.

2. A method according to claim 1, in which said flushing means flushes said long-latency instruction and only instructions in said nth thread that are dependent on said long-latency instruction, leaving instructions in said nth thread that are not dependent on said long-latency instruction in said queue.

3. A method according to claim 1, in which said detection means detects an instruction that has a cache miss as a long-latency instruction.

4. A method according to claim 3, in which said flushing means stores said long-latency instruction flushed from said queue in a latency queue.

5. A method according to claim 2, in which said detection means detects an instruction that has a cache miss as a long-latency instruction.

6. A method according to claim 5, in which said flushing means stores said long-latency instruction flushed from said queue in a latency queue.

7. A method according to claim 1, in which said queue contains a queue number of slots for instructions;
empty slots resulting from the flushing of instructions from said queue are filled by instructions from other threads; and
instructions are added to said queue from the other threads to maintain said queue number of slots filled.

8. A method according to claim 1, in which said detection means detects a lengthy instruction as a long-latency instruction and transfers said lengthy instruction to a lengthy-instruction queue operatively connected to slow instruction operating hardware.

9. A method according to claim 8, in which said flushing means flushes said long-latency instruction and only instructions in said nth thread that are dependent on said long-latency instruction, leaving instructions in said nth thread that are not dependent on said long-latency instruction in said queue.

10. A method according to claim 8, in which said detection means detects a division instruction as a lengthy instruction.

11. A method according to claim 8, in which said lengthy instruction is operated on by slow instruction operation means connected to said lengthy-instruction queue; and
the result of said lengthy instruction is transferred to an output of said queue.

12. A computer processor system comprising a set of operating units and queues for instructions sorted in at least two threads and waiting to use said operating units comprising:
at least one detection means for detecting long-latency instructions in the queue for at least one operating unit;
flushing means for flushing instructions from an nth thread that are in said queue when a long-latency instruction is detected by said detection means in said nth thread; and
means for continuing to operate or instructions in other threads of said at least two threads that are not flushed from said queue.

13. A system according to claim 12, in which said flushing means flushes said long-latency instruction and only instructions in said nth thread that are dependent on said long-latency instruction, leaving instructions in said nth thread that are not dependent on said long-latency instruction in said queue.

14. A system according to claim 12, in which said detection means detects an instruction that has a cache miss as a long-latency instruction.

15. A system according to claim 12, in which said queue contains a queue number of slots for instructions;
empty slots resulting from the flushing of instructions from said queue are filled by instructions from other threads; and
instructions are added to said queue from the other threads to maintain said queue number of slots filled.

16. A system according to claim 12, in which said detection means detects a lengthy instruction as a long-latency instruction and transfers said lengthy instruction to a lengthy-instruction queue operatively connected to slow instruction operating hardware.

17. A system according to claim 8, in which said lengthy instruction is operated on by slow instruction operation means connected to said lengthy-instruction queue; and
the result of said lengthy instruction is transferred to an output of said queue.

18. An article of manufacture in computer readable form comprising means for performing a method for operating a computer system having a program, said method comprising the steps of:
executing instructions sorted in at least two threads in a processor system comprising at least one operating unit having a queue for instructions waiting to use said operating units in which:
at least one detection means detects long-latency instructions in the queue for said at least one operating unit;
flushing means flushes instructions of an nth thread that are in said queue when a long-latency instruction in said nth thread is detected by said detection means; and
instructions in other threads of said at least two threads are not flushed from said queue.

19. An article of manufacture according to claim 18, in which said flushing means flushes said long-latency instruction and only instructions in said nth thread that are dependent on said long-latency instruction, leaving instructions in said nth thread that are not dependent on said long-latency instruction in said queue.

20. An article of manufacture according to claim 18, in which said queue contains a queue number of slots for instructions;
empty slots resulting from the flushing of instructions from said queue are filled by instructions from other threads; and
instructions are added to said queue from the other threads to maintain said queue number of slots filled.
